(19) United States
(12) Patent Application Publication
(10) Pub. No.: US 2024/0052995 A1
(43) Pub. Date: Feb. 15, 2024

(54) SHAPEABLE DECORATIVE LIGHT

(71) Applicant: Yung-Chen HSU, New Taipei City (TW)

(72) Inventor: Yan LIU, Dongguan (CN)

(73) Assignee: Yung-Chen HSU, New Taipei City (TW)

(21) Appl. No.: 18/365,501

(22) Filed: Aug. 4, 2023

(30) Foreign Application Priority Data
Aug. 15, 2022 (CN) 202222145100.6

(51) Int. Cl. F21V 19/00; F21S 4/26

(52) U.S. Cl. CPC F21V 19/004; F21S 4/26; F21Y 2115/10

(57) ABSTRACT

A shapeable decorative light includes a shapeable light line and a fixing assembly for gathering the light line together and holding the light line in place. The light line includes a light-emitting diode (LED) light string, a shapeable line body, and a pliable light-permeable member, the three of which extend in the same direction. The light-permeable member and the LED light string can be bent and shaped along with the shapeable line body in order to render the light line into a predetermined shape. The fixing assembly includes a plurality of fixing portions for insertion by the light line and for holding the light line in place and thereby fixing the relative positions of the light line and the fixing assembly such that the light line forms a plurality of shapeable light sections outside the fixing assembly. The shapeable decorative light can be easily assembled, shaped, and installed for decoration.

### BACKGROUND OF THE INVENTION

### 1. Technical Field

The present invention relates to a decorative light that can be creatively styled. More particularly, the invention relates to a decorative light that can be easily assembled, shaped, and installed for decoration.

### 2. Description of Related Art

Light-emitting diode (LED) light strings and LED light strips have recently become highly popular decorative light products among consumers. An LED light string or light strip is composed essentially of a plurality of connected LED beads or LED chips and can be arranged according to the place to be decorated so as to produce the desired decorative effect. LED light strings and light strips have been widely used in our daily lives and living environments.

The main body of a conventional LED light string includes pliable conductive wires that connect the LED beads. In addition to being used as is for site decoration, a conventional LED light string can be wound into a decorative item of a specific shape by being fixedly attached to an object with an auxiliary fixing device such as tying strings. The use of the auxiliary fixing device, however, renders the installation process inconvenient and makes it difficult to move or reuse the decorative item.

### BRIEF SUMMARY OF THE INVENTION

Given the foregoing drawbacks of the prior art, the primary objective of the present invention is to provide a decorative light that can be shaped. It is desirable that this decorative light not only can be assembled and arranged with ease, but also can be freely and easily shaped as desired and be reused in different environments.

To achieve the aforesaid objective, the major technical means and structural features used in the present invention include a shapeable light line and a fixing assembly. The light line includes an LED light string, a shapeable line body that can be bent, and a pliable light-permeable member. The LED light string, the shapeable line body, and the light-permeable member extend in the same direction. The LED light string and the shapeable line body are received in the light-permeable member. The light-permeable member and the LED light string can be bent and shaped along with the shapeable line body in order to render the light line into a predetermined shape. The fixing assembly is configured to gather the light line together and hold the light line in place and is provided with a plurality of fixing portions through which the light line can be inserted and with which the light line can be held in place. The light line can be bent and inserted through the fixing portions such that the relative positions of the light line and the fixing assembly are fixed, with the light line forming a plurality of light sections outside the fixing assembly. The shapeable decorative light can then be rendered into a predetermined form by shaping the light sections.

The foregoing structures may be so designed that the fixing assembly includes a base, that the fixing portions are arranged on and along the periphery of the base in an annular manner, and that each fixing portion includes at least one line fastener for holding the light line in place.

Preferably, each fixing portion includes two line fasteners for holding the light line in place, the two line fasteners of each fixing portion are defined as a first line fastener and a second line fastener, one of the first line fastener and the second line fastener of each fixing portion is inserted by the light line inward of the fixing assembly, and the other of the two line fasteners of each fixing portion is inserted by the light line outward of the fixing assembly.

The foregoing structures may be so designed that the light line includes a first end and a second end, that the first end and the second end are each inserted through one or the other of the first line fastener and the second line fastener of one of the fixing portions, and that the first end and the second end are inside the fixing assembly.

The foregoing structures may be so designed that the LED light string is electrically connected to a power connector at at least one of the first end and the second end of the light line.

The foregoing structures may be so designed that the LED light string includes at least two conductive wires and a plurality of LED beads provided at intervals on and along the conductive wires.

The foregoing structures may be so designed that the shapeable line body is composed of a metal material that can be bent and fixed in shape, such as iron, copper, nickel, stainless steel, carbon steel, or other metal materials that are flexible and can be fixed in shape; and that the light-permeable member is composed of a transparent or translucent silicone material, rubber material, or polyvinyl chloride (PVC) material.

According to the present invention, the shapeable line body, which is composed of metal and can be bent and shaped, allows the shapeable light line to be bent into a regular or irregular shape, and the fixing assembly allows insertion by the light line and can thereby gather the light line together and hold the light line in place to facilitate assembly and help keep the light line in shape so that a user can freely shape the light sections, which are exposed from the fixing assembly, to render the shapeable decorative light into a predetermined form. The shapeable decorative light, therefore, not only provides convenience of use, but also can be moved between and reused in different environments.

### BRIEF DESCRIPTION OF THE SEVERAL VIEWS OF THE DRAWINGS

The objectives, effects, and technical features of the present invention can be better understood by referring to the following detailed description of some preferred embodiments in conjunction with the accompanying drawings, in which:

FIG. 1 schematically shows the structure of a preferred embodiment of the invention;

FIG. 2 is an exploded view of the embodiment shown in FIG. 1;

FIG. 3 schematically shows the structure of the shapeable light line of the invention;

FIG. 4 schematically shows the structure of the fixing assembly of the invention;

FIG. 5 schematically shows the structure of another preferred embodiment of the invention; and

FIG. 6 is an exploded view of the embodiment shown in FIG. 5.

### DETAILED DESCRIPTION OF THE INVENTION

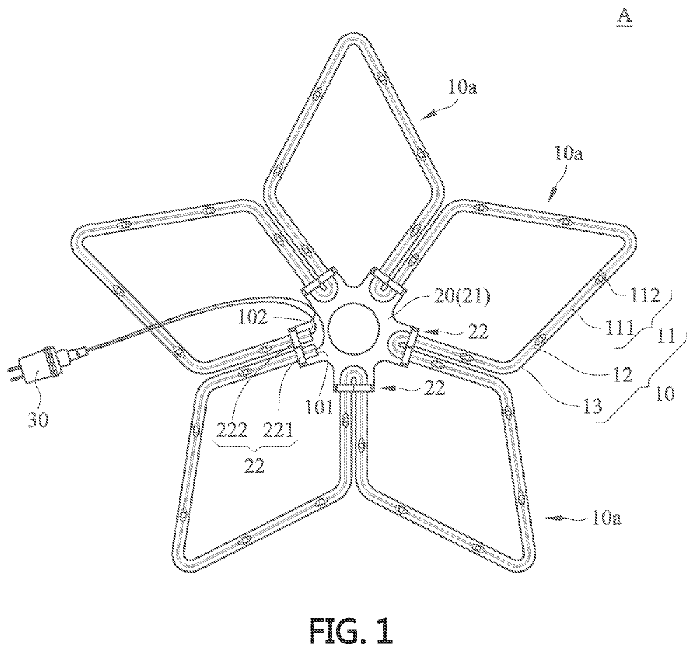

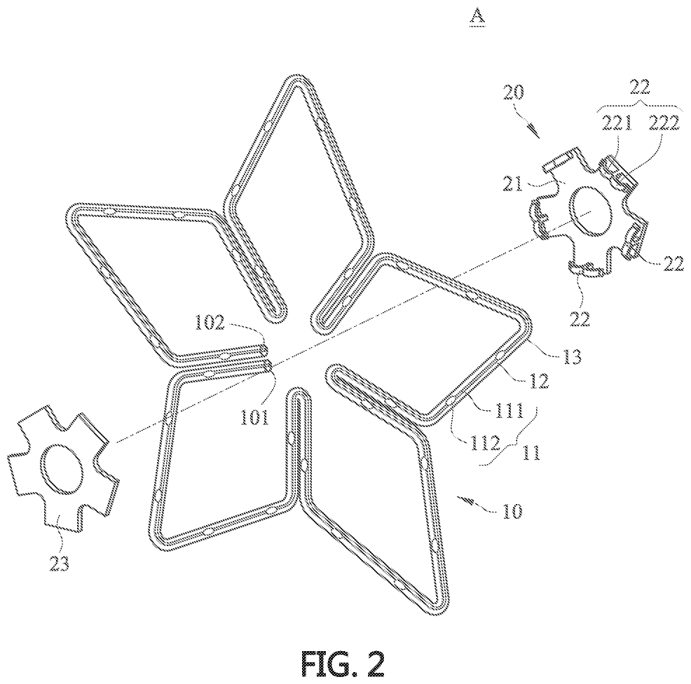

Referring to FIG. 1 and FIG. 2 for schematic drawings of the shapeable decorative light A according a preferred embodiment of the present invention, the shapeable decorative light A essentially includes a shapeable light line 10 and a fixing assembly 20.

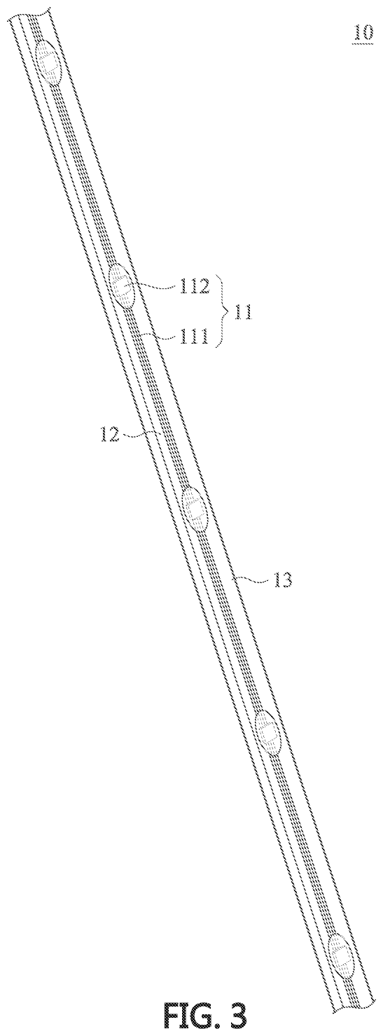

Referring to FIG. 3, the structure of the light line 10 in this embodiment essentially includes an LED light string 11, a shapeable line body 12 that can be bent, and a pliable light-permeable member 13. The LED light string 11, the shapeable line body 12, and the light-permeable member 13 extend in the same direction. The LED light string 11 is composed of at least one conductive wire 111 for supplying electricity and a plurality of LED beads 112 that are provided at intervals on and along the conductive wire 111. In this embodiment, the LED light string 11 uses a double-wire cable as the at least one conductive wire 111 and to connect the LED beads 112, which are arranged at intervals. The shapeable line body 12 is composed essentially of a metal material such as iron, copper, nickel, stainless steel, or carbon steel, and serves to provide the light line 10 with the ability to be bent and shaped by an applied force and to be fixed in shape. The light-permeable member 13 is composed of a transparent or translucent silicone material, rubber material, or PVC material; functions as an enclosing material of the light line 10; and is wrapped around the LED light string 11 and the shapeable line body 12 such that the LED light string 11 and the shapeable line body 12 are received in the cavity formed in the light-permeable member 13. With the shapeable line body 12 providing the ability to be shaped, and the light-permeable member 13 and the LED light string 11 being able to be bent and shaped along with the shapeable line body 12, the light line 10 can be easily rendered into a predetermined shape.

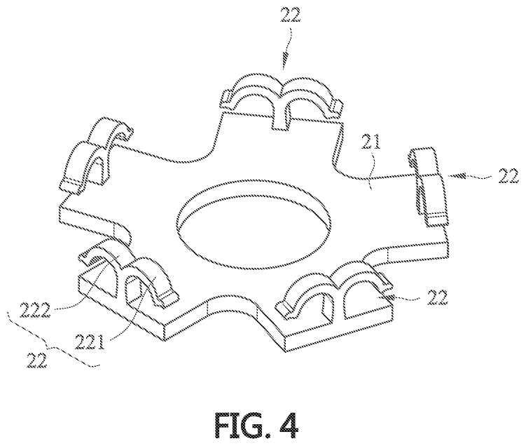

Referring to FIG. 4, the fixing assembly 20, which serves mainly to gather the light line 10 together and hold the light line 10 in place, includes a base 21, a plurality of fixing portions 22, and a cover portion 23. The fixing portions 22 are arranged on and along the periphery of the base 21 in an annular manner. The cover portion 23 is configured to cover the side of the fixing portions 22 that faces away from the base 21. In this embodiment, each fixing portion 22 includes a first line fastener 221 and a second line fastener 222, both of which are configured for insertion by the light line 10 and for holding the light line 10 in place, with one of the two line fasteners inserted by the light line 10 inward of the fixing assembly 20 and the other line fastener inserted by the light line 10 outward of the fixing assembly 20. By bending the light line 10, the light line 10 can be inserted into and out of the fixing portions 22 such that not only are the light line 10 and the fixing assembly 20 fixed in position with respect to each other, but also a plurality of light sections 10a are formed. The light sections 10a are located outside the fixing assembly 20 and each have an appropriate length so that a user can freely shape the light sections 10a and thereby render the shapeable decorative light A into a predetermined form according to practical needs.

In one feasible embodiment, the light line 10 has a first end 101 and a second end 102. The first end 101 and the second end 102 are inserted through one of the fixing portions 22 (i.e., with one of the two ends inserted through one of the first line fastener 221 and the second line fastener 222 of the fixing portion 22, and the other of the two ends inserted through the other of the two line fasteners) and are thereby fixed inside the fixing assembly 20. In practice, at least one of the first end 101 and the second end 102 is connected with a power connector 30 for connecting with a power source.

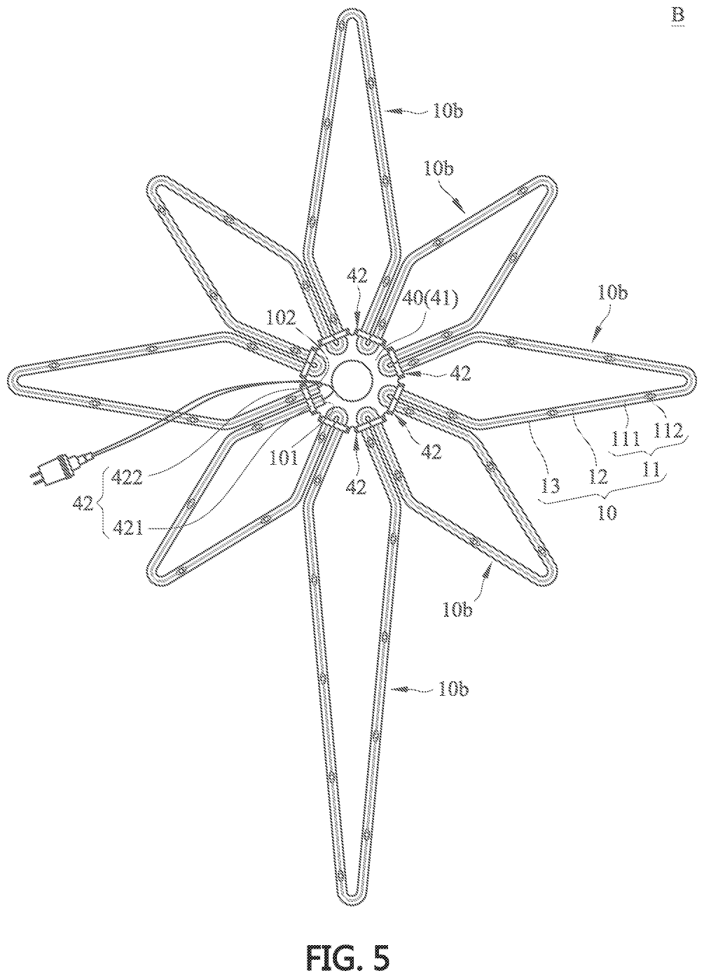

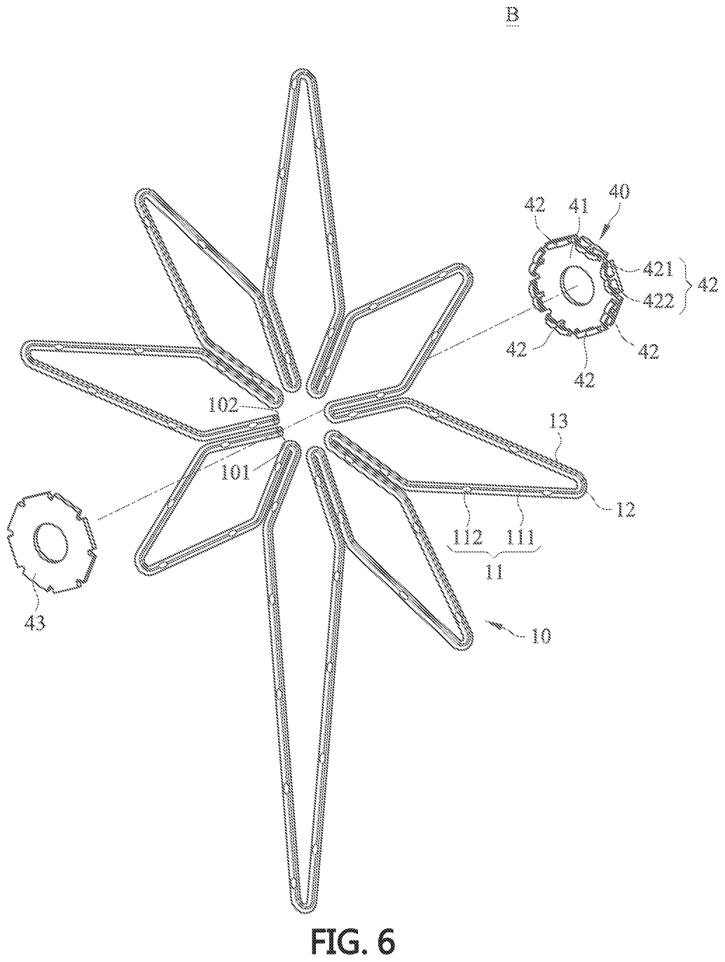

Referring to FIG. 5 and FIG. 6 for schematic drawings of the shapeable decorative light B according to another preferred embodiment of the present invention, the shapeable decorative light B includes a shapeable light line 10 and a fixing assembly 40. The shapeable decorative light B is different from the shapeable decorative light A in the previous embodiment in that the fixing assembly 40 is provided with more fixing portions 42, and that in consequence the number of the light sections 10b formed by inserting the light line 10 into and out of the fixing assembly 40 can be greater than that of the light sections 10a. This allows the shapeable decorative light B to be shaped differently from the shapeable decorative light A.

The light line 10 in this embodiment has the same structural composition as its counterpart in the previous embodiment (see FIG. 3) and therefore will not be described in more detail. The fixing assembly 40 in this embodiment is similar to the fixing assembly 20 in that it also includes a base 41, a plurality of fixing portions 42, and a cover portion 43, the difference being that the fixing portions 42 outnumber the fixing portions 22 of the fixing assembly 20. The fixing portions 42 are nevertheless also arranged on and along the periphery of the base 41 in an annular manner, and the cover portion 43 is configured to cover the side of the fixing portions 42 that faces away from the base 41.

In this embodiment, each fixing portion 42 includes a first line fastener 421 and a second line fastener 422, both of which are configured for insertion by the light line 10 and for holding the light line 10 in place, with one of the two line fasteners inserted by the light line 10 inward of the fixing assembly 40 and the other line fastener inserted by the light line 10 outward of the fixing assembly 40. By bending the light line 10, the light line 10 can be inserted into and out of the fixing portions 42 such that not only are the light line 10 and the fixing assembly 40 fixed in position with respect to each other, but also a plurality of light sections 10b are formed. The light sections 10b are located outside the fixing assembly 40 and each have an appropriate length so that a user can freely shape the light sections 10b and thereby render the shapeable decorative light B into a predetermined form according to practical needs.

According to the above, the shapeable decorative lights A and B in the foregoing embodiments are so designed that each shapeable line body 12 provides the corresponding shapeable decorative light with the property of being able to be bent and shaped, that an appropriate fixing assembly 20 or 40 can be used in order to form the desired number of light sections 10a/10b each having the desired length, and that the light sections 10a/10b can be shaped (e.g., bent into regular/irregular shapes or symmetric/asymmetric shapes) in order to render the corresponding shapeable decorative light A/B into a predetermined form. The fixing assemblies 20 and 40 in the invention can effectively hold the shapeable light line 10 in shape and prevent the light line 10 from being easily deformed so that the light sections 10a and 10b, which are exposed from the fixing assembly 20 or 40, can be freely shaped by a user. Therefore, in addition to allowing changes in shape, the shapeable decorative lights A and B provide greater convenience of use than the prior art and can be readily moved between and reused in different environments.

The embodiments described above are only some preferred ones of the present invention. Any extension, modification, simple change, or equivalent substitution based on the technical means of the invention shall be viewed as falling within the scope of the appended claims.

What is claimed is:

1. A shapeable decorative light, comprising:
a shapeable light line, wherein the shapeable light line includes a light-emitting diode (LED) light string, a shapeable line body able to be bent, and a pliable light-permeable member; the LED light string, the shapeable line body, and the light-permeable member extend in a same direction; the LED light string and the shapeable line body are received in the light-permeable member; and the light-permeable member and the LED light string are able to be bent and shaped along with the shapeable line body in order to render the light line into a predetermined shape; and
a fixing assembly, wherein the fixing assembly is configured to gather the light line together and hold the light line in place and is provided with a plurality of fixing portions for insertion by the light line and for holding the light line in place; the light line is able to be bent and inserted through the fixing portions to not only fix relative positions of the light line and the fixing assembly, but also form a plurality of light sections outside the fixing assembly; and the light sections are able to be shaped in order to render the shapeable decorative light into a predetermined form.

2. The shapeable decorative light of claim 1, wherein the fixing assembly includes a base, and the fixing portions are arranged on and along a periphery of the base in an annular manner.

3. The shapeable decorative light of claim 1, wherein the light line includes a first end and a second end, and the first end and the second end are inside the fixing assembly.

4. The shapeable decorative light of claim 2, wherein each of the fixing portions includes at least one line fastener for holding the light line in place.

5. The shapeable decorative light of claim 1, wherein each of the fixing portions includes a first line fastener and a second line fastener, both configured to hold the light line in place, one of the first line fastener and the second line fastener of each said fixing portion is inserted by the light line inward of the fixing assembly, and the other of the first line fastener and the second line fastener of each said fixing portion is inserted by the light line outward of the fixing assembly.

6. The shapeable decorative light of claim 5, wherein the light line includes a first end and a second end, the first end and the second end are each inserted through one or the other of the first line fastener and the second line fastener of one of the fixing portions, and the first end and the second end are inside the fixing assembly.

7. The shapeable decorative light of claim 6, wherein the LED light string is electrically connected to a power connector at at least one of the first end and the second end of the light line.

8. The shapeable decorative light of claim 7, wherein the LED light string includes at least two conductive wires and a plurality of LED beads provided at intervals on and along the conductive wires.

9. The shapeable decorative light of claim 8, wherein the shapeable line body is composed of a metal material able to be bent and fixed in shape.

10. The shapeable decorative light of claim 9, wherein the metal material is iron, copper, nickel, stainless steel, or carbon steel.

11. The shapeable decorative light of claim 8, wherein the light-permeable member is composed of a transparent or translucent silicone material, rubber material, or polyvinyl chloride (PVC) material.

12. The shapeable decorative light of claim 2, wherein each of the fixing portions includes a first line fastener and a second line fastener, both configured to hold the light line in place, one of the first line fastener and the second line fastener of each said fixing portion is inserted by the light line inward of the fixing assembly, and the other of the first line fastener and the second line fastener of each said fixing portion is inserted by the light line outward of the fixing assembly.

13. The shapeable decorative light of claim 12, wherein the light line includes a first end and a second end, the first end and the second end are each inserted through one or the other of the first line fastener and the second line fastener of one of the fixing portions, and the first end and the second end are inside the fixing assembly.

14. The shapeable decorative light of claim 13, wherein the LED light string is electrically connected to a power connector at at least one of the first end and the second end of the light line.

15. The shapeable decorative light of claim 14, wherein the LED light string includes at least two conductive wires and a plurality of LED beads provided at intervals on and along the conductive wires.

16. The shapeable decorative light of claim 15, wherein the shapeable line body is composed of a metal material able to be bent and fixed in shape.

17. The shapeable decorative light of claim 16, wherein the metal material is iron, copper, nickel, stainless steel, or carbon steel.

18. The shapeable decorative light of claim 15, wherein the light-permeable member is composed of a transparent or translucent silicone material, rubber material, or polyvinyl chloride (PVC) material.
